(19) United States
(12) Patent Application Publication
(10) Pub. No.: US 2026/0078697 A1
(43) Pub. Date: Mar. 19, 2026

(54) H2O PERFORMANCE AND DURABILITY AUGMENTATION

(71) Applicant: RTX CORPORATION, Farmington, CT (US)

(72) Inventors: Brandon M. Evans, San Antonio, TX (US); Neil J. Terwilliger, Cheshire, CT (US)

(21) Appl. No.: 18/813,766

(22) Filed: Aug. 23, 2024

(51) Int. Cl. F02C 3/30; B64D 27/10; B64D 31/04; B64D 45/00; F02C 7/141

(52) U.S. Cl. CPC F02C 3/305; B64D 27/10; B64D 31/04; B64D 45/00; F02C 7/141

(57) ABSTRACT

An aircraft propulsion system includes a core engine that includes a core flow path through a main compressor where an inlet airflow is compressed and communicated to a combustor to generate an exhaust gas flow that is expanded through a main turbine section to generate power used to drive the main compressor and a propulsive fan. A water augmentation system includes a tank where water is stored and at least one location where water is communicated into the core flow path, and a controller programmed to operate the water augmentation system according to a selected mode of operation, a detected quantity of water and other conditions impacting engine operation.

### TECHNICAL FIELD

The present disclosure relates generally to an aircraft propulsion system with a mode selectable water augmentation system.

### BACKGROUND

Gas turbine engines typically include a compressor where inlet air is compressed and delivered into a combustor. In the combustor, the compressed air is mixed with fuel and ignited to generate an exhaust gas flow. Water may be injected into the core flow at different locations to improve engine power, emissions, and durability. The specific location and type of water augmentation that most benefits engine performance may vary based on many different engine and ambient operating parameters.

### SUMMARY

An aircraft propulsion system according to an exemplary embodiment of this disclosure includes, among other possible things, a core engine that includes a core flow path through a main compressor where an inlet airflow is compressed and communicated to a combustor to generate an exhaust gas flow that is expanded through a main turbine section to generate power used to drive the main compressor and a propulsive fan, a water augmentation system that includes a tank where water is stored and at least one location where water is communicated into the core flow path, and a controller programmed to operate the water augmentation system according to a selected mode of operation, a detected quantity of water and other conditions impacting engine operation.

In a further embodiment of the foregoing aircraft propulsion system, the augmentation system includes an intercooling system where water is injected into the compressor section for cooling a portion of an airflow through the compressor section.

In a further embodiment of any of the foregoing aircraft propulsion systems, the augmentation system includes a combustor injection system where water is injected into the combustor to increase a mass flow of the exhaust gas expanded through the main turbine section.

In a further embodiment of any of the foregoing aircraft propulsion systems, the augmentation system includes an injection location into a turbine cooling air flow.

In a further embodiment of any of the foregoing aircraft propulsion systems, the water augmentation system further includes a monitoring system configured to generate information indicative of an amount of water available for use by the augmentation system.

In a further embodiment of any of the foregoing aircraft propulsion systems, the water augmentation system further includes a control system operated by the controller for adjusting operation of the water augmentation system.

In a further embodiment of any of the foregoing aircraft propulsion systems, the control system includes a valve system configured to control a flow of water for the water augmentation system.

In a further embodiment of any of the foregoing aircraft propulsion systems, the controller is further programmed to determine a net engine thrust for a selected flight profile and to determine an amount of water required to operate at the selected flight profile.

In a further embodiment of any of the foregoing aircraft propulsion systems, the selected mode of operation includes one of a durability mode, an emission reduction mode, a thrust augmentation mode, and a waterless operation mode.

In a further embodiment of any of the foregoing, the aircraft propulsion system further includes an operator selectable switch where an aircraft operator selects the operation mode.

A method of controlling an aircraft propulsion system according to another exemplary embodiment of this disclosure includes, among other possible things, selecting an operating mode of a water augmentation system, determining a first amount of water required to operate an aircraft propulsion system according to the selected operating mode of the water augmentation system, determining a second amount of water available for use by the water augmentation system, performing at least one of based on a determination that the first amount of water is greater than the second amount of water, generating an alert to communicate that additional water is needed, or based on a determination that the first amount of water is equal to or greater than the second amount of water, communicating that sufficient water is available to operate the water augmentation system according to the selected operating mode, and initiating operation of the water augmentation system and aircraft propulsion system according to the selected operating mode.

In a further embodiment of the foregoing method, selecting the operating mode of the water augmentation system includes selecting one of a durability mode, an emission reduction mode, and a thrust augmentation mode.

In a further embodiment of any of the foregoing methods, the water augmentation system is configured to introduce water into one of a compressor section and a turbine section of the aircraft propulsion system in the durability mode.

In a further embodiment of any of the foregoing methods, the water augmentation system is configured to introduce water into a combustor section of the aircraft propulsion system in one of an emission reduction mode and a thrust augmentation mode.

In a further embodiment of any of the foregoing, the method further includes determining a net thrust requirement for the aircraft propulsion system and selecting the mode of operation is based at least in part on the determined net thrust requirement.

In a further embodiment of any of the foregoing, the method further includes determining an available thrust in response to the selected mode of operation and the determined amount of available water.

In a further embodiment of any of the foregoing, the method further includes determining if available water storage is sufficient to hold the water required to operate the water augmentation system according to the selected operating mode and communicating the determination of available water storage.

An aircraft propulsion system according to another exemplary embodiment of this disclosure includes, among other possible things, a core engine that includes a core flow path through a main compressor where an inlet airflow is compressed and communicated to a combustor to generate an exhaust gas flow that is expanded through a main turbine section to generate power used to drive the main compressor and a propulsive fan, a water augmentation system that includes a tank where water is stored and at least one location where water is communicated into the core flow path, an operator selectable switch for selecting a mode of operation, the selected mode of operation includes at least one of a durability mode, an emission reduction mode, a thrust augmentation mode, and a waterless operation mode, and a controller programmed to determine a net engine thrust requirement, to determine an amount of water required to operate the water augmentation system according to the selected mode and to operate the water augmentation system according to a selected mode of operation.

In a further embodiment of the foregoing aircraft propulsion system, the augmentation system includes an intercooling system where water is injected into the compressor section for cooling a portion of an airflow through the compressor section and a combustor injection system where water is injected into the combustor to increase a mass flow of the exhaust gas expanded through the main turbine section.

In a further embodiment of any of the foregoing aircraft propulsion systems, the water augmentation system further includes a control system operated by the controller for adjusting operation of the water augmentation system according to the selected operating mode.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example aircraft propulsion system including a water augmentation system.

FIG. 2 is a simplified schematic view of the example controller for the example aircraft propulsion system.

FIG. 3 is a schematic view of a part of a process for operating a water augmentation system.

FIG. 4 is schematic view of another part of the process for operating the aircraft propulsion system with the water augmentation system.

### DETAILED DESCRIPTION

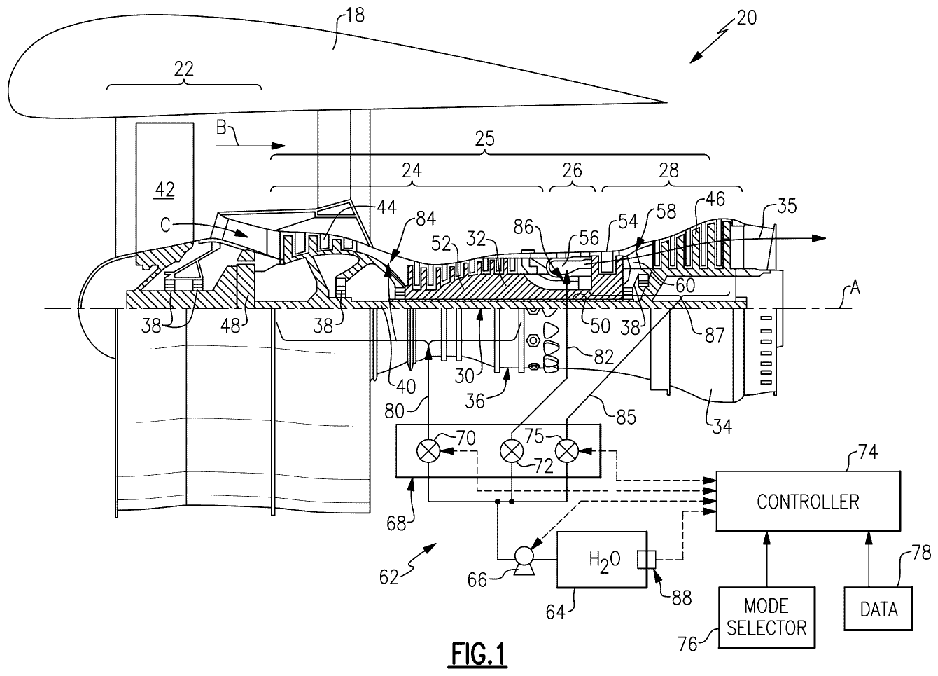

FIG. 1 schematically illustrates an aircraft propulsion system 20 that includes a water augmentation system 62 for augmenting engine operation according to a selected mode of operation. A mode selector 76 provides for the selection of different modes of operation to augment engine operation based on data 78 that is indicative of flight operation and ambient conditions. The example water augmentation system 62 is operable according to a selected mode to increase engine life and durability, reduce emissions and augment thrust.

The example propulsion system 20 is disclosed as a two-spool turbofan that generally incorporates a fan section 22 and a core engine 25 that generates an exhaust gas flow for driving the fan section 22. The core engine 25 includes a compressor section 24, a combustor section 26, and a turbine section 28. The fan section 22 may include a single-stage fan having a plurality of fan blades 42. The fan blades 42 may have a fixed stagger angle or may have a variable pitch to direct incoming airflow from an engine inlet. The fan section 22 drives air along a bypass flow path B defined within a nacelle 18, and also drives air along a core flow path C for compression and communication into the combustor section 26 then expansion through the turbine section 28. Exhaust gas flow 35 is finally exhausted through a nozzle 34.

The exemplary core engine 25 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner engine shaft 40 that interconnects a first (or low) pressure compressor 44 and a first (or low) pressure turbine 46. The inner engine shaft 40 is connected to the fan section 22 through a speed change mechanism, which in one example is illustrated as a geared architecture 48 to drive the fan section 22 at a lower speed than the low speed spool 30. The inner engine shaft 40 may interconnect the low pressure compressor 44 and low pressure turbine 46 such that the low pressure compressor 44 and low pressure turbine 46 are rotatable at a common speed and in a common direction. Although this application discloses geared architecture 48, its teaching may benefit direct drive engines having no geared architecture.

The high speed spool 32 includes an outer engine shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 58 of the engine static structure 36 may be arranged generally between the high pressure turbine 54 and the low pressure turbine 46. The mid-turbine frame 58 further supports bearing systems 38 in the turbine section 28. The inner engine shaft 40 and the outer engine shaft 50 are concentric and rotate via bearing systems 38 about the engine central longitudinal axis A which is collinear with their longitudinal axes.

Although an example engine architecture is disclosed by way of example, other turbine engine architectures are within the contemplation and scope of this disclosure. Moreover, although the disclosed non-limiting embodiment depicts a turbofan turbine engine, it should be understood that the concepts described herein are not limited to use with turbofans as the teachings may be applied to other types of turbine engines. Additionally, the features of this disclosure may be applied to other engine configurations utilized to generate shaft power.

The water augmentation system 62 includes a water tank 64, a water pump 66 and a valve system 68. The valve system 68 includes at least a first valve 70, a second valve 72, and a third valve 75. The example water augmentation system 62 includes a first circuit 80, a second circuit 82, and a third circuit 85. The first circuit 80 provides water to the compressor section 24. The second circuit 82 provides water to the combustor section 26. The third circuit 85 provides water to the turbine section 28.

Water through the first circuit 80 to the compressor section 24 may be injected directly into the core flow C to provide intercooling between compressor sections 44, 52. Alternatively, an intercooling water flow may provide a water flow that is not injected into the core flow C, but placed in thermal communication to cool the core flow C.

In one disclosed example, water is injected at a location 84 between compressor sections 44, 52. The injected water cools the core flow C and also increases mass flow. Cooling of the core flow C reduces engine wear and can compensate for operation on hotter than average days. Moreover, the introduction of water into the compressor section 24 may enable operation from high altitude airports and/or high temperature locations by maintaining engine operation within desired operating temperatures.

The introduction of water through the second circuit 82 into the combustor section 26 may augment available engine thrust by increasing mass flow through the turbine section 28. In one example embodiment, water is injected at the location 86 directly into the combustor 56. The introduction of water into the combustor section 26 improves engine efficiencies by increasing mass flow through the turbine section 28 to generate power without requiring additional work in the compressor section 24.

Water may also be used to aid cooling of portions of the turbine section 28. In one example embodiment, water through the third circuit 85 is injected at a location 87 within the turbine section 28 and is used to cool a cooling air flow within the turbine section 28. Cooling of the cooling air provides for lowering the temperature of the cooling air and therefore decreases the temperature and increases the life of the components within the turbine section 28. Cooling of the cooling air may be accomplished by injecting water into a cooling flow before the cooling flow is used, or by passing the cooling flow through a heat exchanger to accept heat from the cooling air flow.

Although example water injection locations and uses are described by way of example, the water augmentation system 62 may be configured to introduce water anywhere along the core flow path C to either mix with the core flow C and/or cool the core flow C. Moreover, the example water augmentation system 62 is disclosed by way of example and may include additional injection locations and/or cooling configurations.

The water augmentation system 62 is controlled by the controller 74 in view of the received data 78 and a selected mode. The controller 74 operates the water augmentation system 62 through control of the valve system 68. The valve system 68 may include additional valving, pumps, conduits, and other flow control devices utilized to control, direct, and communicate water to the core engine 25.

The water tank 64 is shown schematically and may include several tanks arranged throughout an aircraft and the aircraft propulsion system 20. A monitoring device 88 is associated with the water tank 64 and provides information to the controller 74 that is indicative of a volume of water available for use by the water augmentation system 62. Although a single monitoring device 88 is shown way of example, the device 88 may include a system of devices utilized to provides information to the controller 74 indicative of the amount of water available.

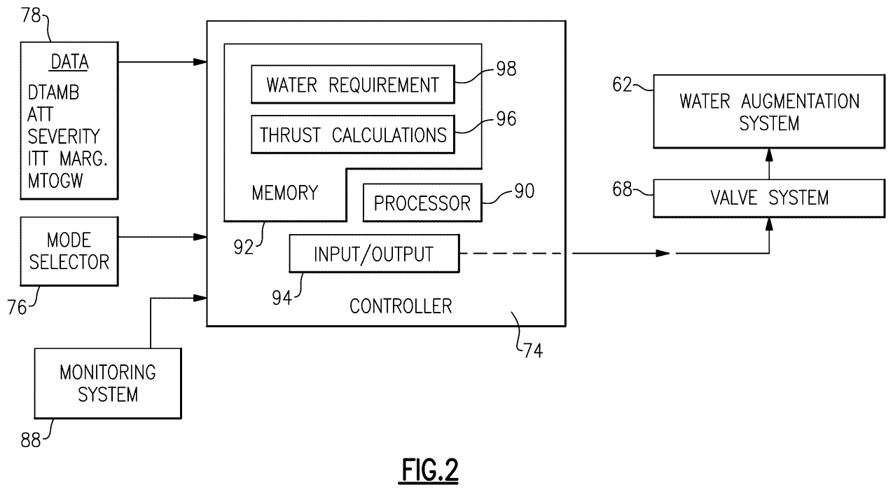

Referring to FIG. 2, with continued reference to FIG. 1, the controller 74 is programmed to operate the water augmentation system 62 and the valve system 68. The controller 74 may further be programmed to operate other systems and devices, such as the pump 66, to facilitate operation of the water augmentation system 62.

The example controller 74 is a device and system including a processor 90, a memory device 92 and an input/output communication module 94 for performing necessary computing or calculation operations of the water augmentation system 62. The memory device 92 may include instructions, modules and/or applications needed for operation of the water augmentation system 62 and the propulsion system 20. In one example embodiment, a thrust calculation module 96 and water requirement module 98 are included in the memory device 92. The modules 96, 98 may include instructions or be separate modules that interact with the controller 74 to provide the necessary information utilizing input information.

In one example embodiment, the controller 74 is configured and programmed to receive data 78 indictive of propulsion system operation, ambient conditions and other information required for calculation of thrust and water requirements. In one example embodiment, the data 78 includes deferential temperature from ambient (DTAMB), altitude (Alt), Severity, interstate turbine temperature margin (ITT marg), runway data (e.g., length, direction, surface, surface temperature, etc.), wind data (e.g., speed, direction, etc.), and maximum take-off gross weight (MTOGW). Severity as used in this disclosure is a factor that refers to wear on the engine for a given flight profile. Although several different data inputs are shown and described by way of example, other data and information may be utilized and included. The data 78 may automatically be provided to the controller 74 (e.g., received from external computing device, sensor data, etc.) or be input by an operator.

The example controller 74 further receives information regarding a mode of operation from the mode selector 76 and information regarding water within the tank 64 from the monitoring device 88. Other information as may be useful to initiate and control operation of the water augmentation system 62 may also be provided and is within the contemplation and scope of this disclosure.

The controller 74 may be specially constructed for operation of the control water augmentation system 62, or it may comprise at least a general-purpose computer selectively activated or reconfigured by software instructions stored in a memory device. The controller 74 may further be part of full authority digital engine control (FADEC) or an electronic engine controller (EEC).

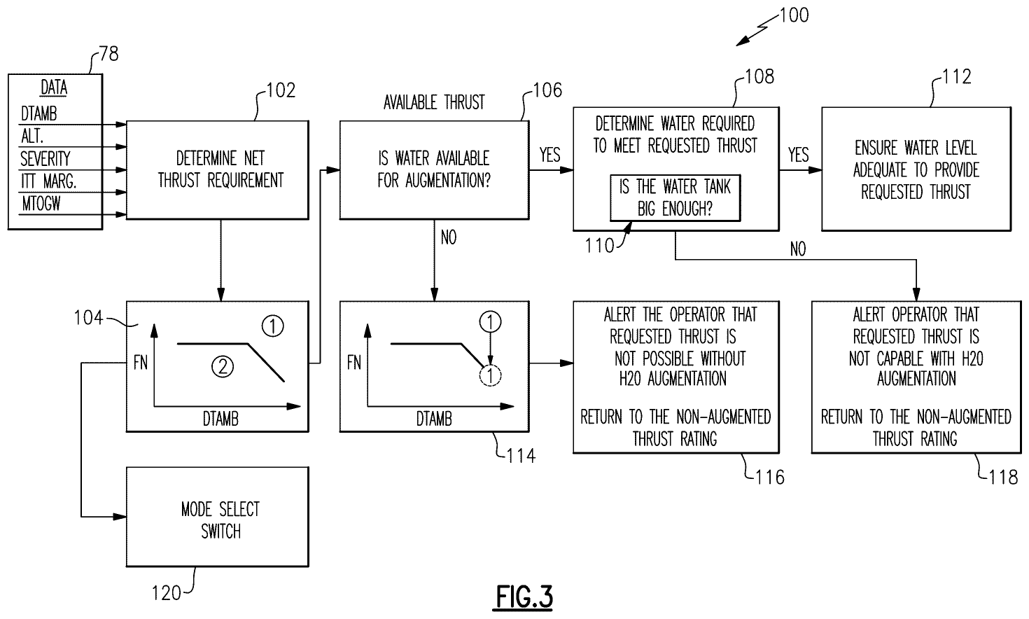

Referring to FIG. 3 with continued reference to FIGS. 1 and 2, a process flow of an example operating embodiment is schematically indicated at 100. The process 100 shows initial steps of setting operation of the water augmentation system 62. In one initial step indicated at 102, a net thrust requirement is determined in view of input data 78. The net thrust requirement determination 102 may be accomplished using the thrust calculation module 96 of the controller 74 or may be determined using external resource materials (e.g., external system configured to receive data related to the engine, aircraft, airfield, etc. and calculate a net thrust requirement). Once the net thrust requirement 102 is determined, a non-augmented available thrust (e.g., a total available thrust without water augmentation) is determined as indicated at 104. The non-augmented available thrust 104 is revised based on current conditions, such as for example the ambient temperature. Other factors may be considered and are within the contemplation of this disclosure.

The non-augmented available thrust 104 may be augmented if water is available and this query is answered as indicated at 106. If water is available, then the process moves to a determination of how much water is required to provide the desired additional available thrust (as augmented available thrust) as is schematically indicted at 108. Other determinations may also be made at this time to confirm operation with water augmentation. In one example, a determination as to the capacity to hold water aboard an aircraft is made as indicated at 110. Other determination that are relevant to operation of the water augmentation system may also be made at this time and are within the contemplation of this disclosure.

Upon further determinations, if the water augmentation system 62 has the capability to hold a sufficient amount of water for the desired augmentation, an actual measurement of the current water level is made as indicated at 112. If sufficient water is present, operation may proceed as determined. If water is not present, the operator and/or a remote aircraft supply management system can instruct further filling of the onboard water tank 64 to accommodate the desired operation of the propulsion system 20 and water augmentation system 62.

If the water tank is not large enough to hold the amount of water required to provide the desired augmentation, the determination is communicated to the operator (e.g., operator or remote aircraft supply management operator) as is indicated at 118. Similarly, if the water augmentation is not available as indicated at 114, the available thrust is downgraded to the non-augmented thrust, and an indication thereof is communicated to the operator as indicated at 116.

The determinations illustrated in process 100 are all either based on a selected mode as indicated at 120, or provide for the selection of an operational mode. The water augmentation system 62 is operable according to a selected mode that each require a unique amount of water. Accordingly, each of the determinations made and illustrated in the process 100 are dependent on the selected mode 120.

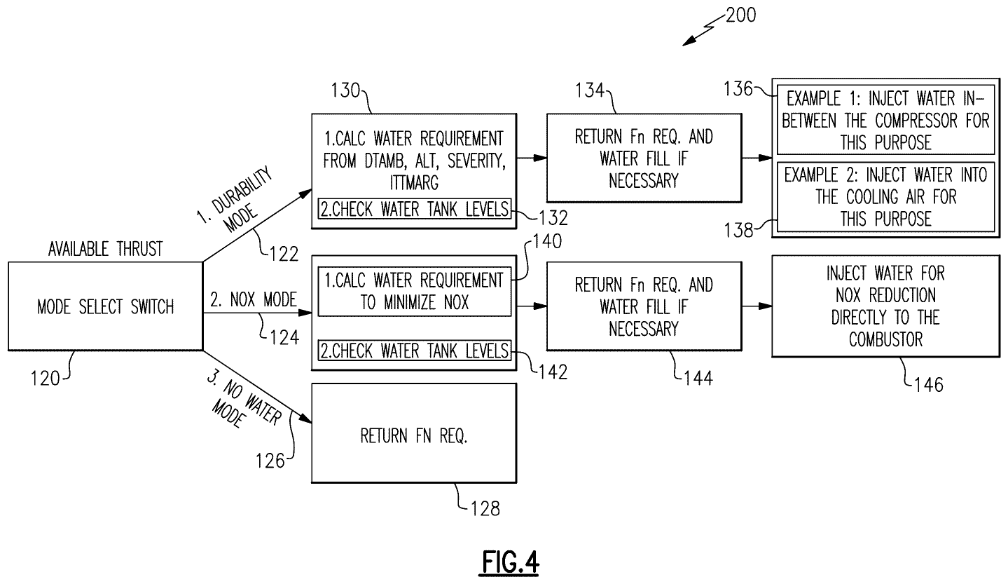

Referring to FIG. 4, with continued reference to FIGS. 1 and 3, the mode selector 120 controls how the water augmentation system 62 operates. The further operation of the water augmentation system 62 is illustrated and indicated at 200. Based on the selected mode 120 determinations are made and confirmed. In one example, available modes of operation include a durability mode 122, a reduced emission mode 124 and a non-augmented operating mode indicated at 126. As appreciated, in the non-augmented mode, no further determinations are required and the propulsion system 20 is set up to operate with the thrust available without water augmentation as indicated at 128.

In the durability mode 122, a calculation is made based on data indicative of wear and life of the engine as is indicated at 130. In one example embodiment, Severity, DTAMB, ALT, and ITTMARG are considered in determining the water requirement for the current flight profile. Upon the determination of the required water, a check of the monitoring system 88 is made to determine if sufficient water is present for such operation as indicated at 132. If sufficient water is not present, additional water can be added as indicated at 134. Water may be added to completely fill the tank 64. Alternatively, water may be added to provide the required amount of water without necessarily filling the entire tank.

Operation proceeds with the water augmentation system 62 introducing water to provides the desired durability augmentation. In one example embodiment, durability augmentation is provided by injecting water between compressor sections as indicated at 136. In another example embodiment, water is injected into a cooling airflow as indicated at 138. Although example uses of water augmentation to improve engine life and durability, other injection locations and water augmentation schemes may be utilized and are within the scope and contemplation of this disclosure.

Operation in an emission reduction mode, shown as NOX mode 124, proceeds with a calculation of the water required as indicated at 140. The water requirement determination 140 further includes a check of water level within the tank 64 as indicated at 142. Further water may be added if needed as indicated at 144. Water may be added to completely fill the tank 64 or to provide only the necessary water required for operation according to the calculation 140. Once the tank 64 is filled, the aircraft propulsion system 20 is operated with water augmentation intended to reduce emissions as indicated at 146. In one example operational embodiment, water is injected directly into the combustor 56 in a manner determined to reduce emissions.

Operation of the water augmentation system 62 as indicated at 136, 138 and 146 may include, among other things, a volume of water, location of water injection, and a rate of water injection. Water may be in liquid form or in gaseous form or in a mixed liquid and gaseous form depending on further operational requirements. In each of the disclosed operating examples, the mode of water augmentation is selected by the operator to augment operation as desired. The selected mode may be implemented at the discretion of the operator. The example water augmentation system provides the operator with capability of selecting operation and assuring sufficient water to implement the desired operation.

Although embodiments of this disclosure have been shown, a worker of ordinary skill in this art would recognize that modifications would come within the scope of this disclosure. For that reason, the following claims should be studied to determine the true scope and content of this disclosure.

What is claimed is:

1. An aircraft propulsion system comprising:
a core engine comprising a core flow path through a main compressor where an inlet airflow is compressed and communicated to a combustor to generate an exhaust gas flow that is expanded through a main turbine section to generate power used to drive the main compressor and a propulsive fan;
a water augmentation system comprising a tank where water is stored and at least one location where water is communicated into the core flow path; and
a controller programmed to operate the water augmentation system according to a selected mode of operation, a detected quantity of water and other conditions impacting engine operation.

2. The aircraft propulsion system as recited in claim 1, wherein the augmentation system comprises an intercooling system where water is injected into the compressor section for cooling a portion of an airflow through the compressor section.

3. The aircraft propulsion system as recited in claim 1, wherein the augmentation system comprises a combustor injection system where water is injected into the combustor to increase a mass flow of the exhaust gas expanded through the main turbine section.

4. The aircraft propulsion system as recited in claim 1, wherein the augmentation system comprises an injection location into a turbine cooling air flow.

5. The aircraft propulsion system as recited in claim 1, wherein the water augmentation system further comprises a monitoring system configured to generate information indicative of an amount of water available for use by the augmentation system.

6. The aircraft propulsion system as recited in claim 1, wherein the water augmentation system further comprises a control system operated by the controller for adjusting operation of the water augmentation system.

7. The aircraft propulsion system as recited in claim 1, wherein the control system comprises a valve system configured to control a flow of water for the water augmentation system.

8. The aircraft propulsion system as recited in claim 1, wherein the controller is further programmed to determine a net engine thrust for a selected flight profile and to determine an amount of water required to operate at the selected flight profile.

9. The aircraft propulsion system as recited in claim 1, wherein the selected mode of operation includes one of a durability mode, an emission reduction mode, a thrust augmentation mode, and a waterless operation mode.

10. The aircraft propulsion system as recited in claim 9, further comprising an operator selectable switch where an aircraft operator selects the operation mode.

11. A method of controlling an aircraft propulsion system comprising:
selecting an operating mode of a water augmentation system;
determining a first amount of water required to operate an aircraft propulsion system according to the selected operating mode of the water augmentation system;
determining a second amount of water available for use by the water augmentation system;
performing at least one of:
based on a determination that the first amount of water is greater than the second amount of water, generating an alert to communicate that additional water is needed; or
based on a determination that the first amount of water is equal to or greater than the second amount of water, communicating that sufficient water is available to operate the water augmentation system according to the selected operating mode; and
initiating operation of the water augmentation system and aircraft propulsion system according to the selected operating mode.

12. The method as recited in claim 11, wherein selecting the operating mode of the water augmentation system comprises selecting one of a durability mode, an emission reduction mode, and a thrust augmentation mode.

13. The method as recited in claim 12, where the water augmentation system is configured to introduce water into one of a compressor section and a turbine section of the aircraft propulsion system in the durability mode.

14. The method as recited in claim 11, wherein the water augmentation system is configured to introduce water into a combustor section of the aircraft propulsion system in one of an emission reduction mode and a thrust augmentation mode.

15. The method as recited in claim 11, further comprising determining a net thrust requirement for the aircraft propulsion system and selecting the mode of operation is based at least in part on the determined net thrust requirement.

16. The method as recited in claim 15, further comprising determining an available thrust in response to the selected mode of operation and the determined amount of available water.

17. The method as recited in claim 15, further comprising determining if available water storage is sufficient to hold the water required to operate the water augmentation system according to the selected operating mode and communicating the determination of available water storage.

18. An aircraft propulsion system comprising:
a core engine comprising a core flow path through a main compressor where an inlet airflow is compressed and communicated to a combustor to generate an exhaust gas flow that is expanded through a main turbine section to generate power used to drive the main compressor and a propulsive fan;
a water augmentation system comprising a tank where water is stored and at least one location where water is communicated into the core flow path;
an operator selectable switch for selecting a mode of operation, wherein the selected mode of operation includes at least one of a durability mode, an emission reduction mode, a thrust augmentation mode, and a waterless operation mode; and
a controller programmed to determine a net engine thrust requirement, to determine an amount of water required to operate the water augmentation system according to the selected mode and to operate the water augmentation system according to a selected mode of operation.

19. The aircraft propulsion system as recited in claim 18, wherein the augmentation system comprises an intercooling system where water is injected into the compressor section for cooling a portion of an airflow through the compressor section and a combustor injection system where water is injected into the combustor to increase a mass flow of the exhaust gas expanded through the main turbine section.

20. The aircraft propulsion system as recited in claim 18, wherein the water augmentation system further comprises a control system operated by the controller for adjusting operation of the water augmentation system according to the selected operating mode.
